(19) United States
(12) Patent Application Publication
(10) Pub. No.: US 2026/0064970 A1
(43) Pub. Date: Mar. 5, 2026

(54) ENTROPY-BASED DETECTION OF THE FLUENCY OF MACHINE-GENERATED TEXT

(71) Applicant: MICROSOFT TECHNOLOGY LICENSING, LLC., REDMOND, WA (US)

(72) Inventors: SAMER AAMAR, DER-ALASAD (IL); ABEDELKADER ASI, SAMMAMISH, WA (US); ROY EISENSTADT, TEL-AVIV (IL); SHAHAR KEREN, HEMED (IL); ALEXANDER TSVETKOV, TEL-AVIV (IL)

(21) Appl. No.: 18/826,012

(22) Filed: Sep. 5, 2024

(51) Int. Cl. G06F 40/284

(52) U.S. Cl. CPC G06F 40/284

(57) ABSTRACT

An entropy-based technique is used to select a large language model capable of generating fluent natural language text. An entropy model, trained on fluent natural language samples, is used to determine the entropy of a large language model based on an output text generated by the large language model. The entropy of a machine-generated natural language text is used to quantify the amount of information that the large language model holds with respect to the tokens and context of an input text segment. The entropy score of a model is then used to select a large language model capable of generating fluent text or to select the most fluent machine-generated output text produced by a set of large language models.

### BACKGROUND

Large language models (LLMs) are often used to generate natural language text for a variety of applications such as question answering, text summarization, language translation, and transcription. There are numerous LLMs available having various capabilities, computational requirements, language support, latency and response times, and cost. A LLM learns to produce natural language text based on its training data which may come from various content sources and from various domains. From this training data, the LLM learns to statistically predict which words to use to generate a sentence for a given context. The LLM generates the output text based on word frequency, the likelihood that a specific word follows another word, or the likelihood of a specific sentence following another sentence.

However, at times, the machine-generated text may be grammatically-correct but not appear as natural as human-written text. The machine-generated text may appear confusing with wordy and choppy sentences and repetitive words which makes the output text unnatural.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An entropy-based technique is used to generate machine-generated fluent natural language text. Entropy is a level of uncertainty and is related to the amount of information a LLM holds. High entropy indicates that the LLM is surprised to see an input text and as such, the LLM holds very little information about the tokens and context of the input text. This indicates that the output text generated by the LLM is likely to be non-fluent. Low entropy indicates low uncertainty and that the LLM is not surprised to see the tokens of an input text. Low entropy indicates that the model holds a lot of information about the tokens and context of the input text and as such indicates that the output text is likely to be fluent.

In one aspect, the entropy score of a machine-generated output text of several LLMs is computed to select one of the LLMs to generate fluent text for a target task. In another aspect, the entropy score of the machine-generated output texts of several LLMs is used to select one of the machine-generated output texts as having fluent natural language.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for an entropy-based generation of the fluency of a natural language text.

FIG. 2 is a schematic diagram illustrating an exemplary architecture of a generative large language model configured as a neural transformer model with encoder and decoder blocks with attention.

FIG. 3 is a flow diagram illustrating an exemplary method of an entropy-based technique for the detection of the fluency of the natural language text generated by a large language model.

FIG. 4 is a flow diagram illustrating an exemplary method for an application of the entropy-based technique for generating fluent natural language.

FIG. 5 is a flow diagram illustrating an exemplary method for generating non-vulgar natural language text.

FIG. 6 is a block diagram illustrating a first exemplary operating environment.

FIG. 7 is a block diagram illustrating a second exemplary operating environment.

### DETAILED DESCRIPTION

### Overview

Aspects of the present disclosure pertain to the detection of the fluency of the natural language text generated by a large language model using an entropy-based technique. The entropy-based technique scores the output text generated by several large language models. The entropy score evaluates the fluency of an output text generated by a large language model for a given input. A large language model having a low entropy score is then selected for a target task or to select the most fluent machine-generated text produced from one of several large language models.

Fluency in a writing refers to conveying information in a way that is natural to a native speaker and which is easily understood. A fluent writing uses words, phrases or expressions that are natural to native speakers, is easily understood by a reader, and grammatically-correct. The automatic generation of fluent natural language text is a complicated task requiring semantic and linguistic knowledge of a natural language (e.g., English, French, etc.). Semantic knowledge pertains to the relationship between individual words in a context and the meaning of the words when they form a sentence. Linguistic knowledge pertains to phonology, morphology, syntax, and pragmatics of a language. Linguistic knowledge is needed to construct phrases to express a specific sentiment.

Machine learning models learn to generate natural language from analyzing the patterns in the samples of its training data. The source of the training data, the domain of the training data, and the amount of training data varies for each LLM and effects the output text generated by an LLM. A machine-generated output text may generate syntactically-correct text that is useless for an intended task since it appears robotic or unnatural and hence non-fluent. The technique disclosed herein selects a LLM for an intended task based on the entropy of the output text generated by the LLM.

Entropy is a measure of uncertainty or disorder in a system. Entropy is related to information content and surprise. Low entropy relates to little uncertainty where outcomes are certain and when realized, reveal little information. High entropy relates to high disorder or uncertainty where outcomes are uncertain and when realized, reveal information. Low entropy is used to detect fluent natural language text and high entropy is used to detect non-fluent natural language text.

The level of uncertainty is related to the amount of information the system holds which is used to access the fluency of a natural language text. High entropy indicates that the model is surprised to see an input sequence and as such, the model holds very little information about the tokens and context of the input sequence. This results in a high entropy score that considers an output text as being non-fluent. Low entropy indicates low uncertainty and that the model is not surprised to see the tokens of an input sequence. Low entropy indicates that the model holds a lot of information about the tokens and context of the input sequence. This results in a low entropy score that considers the output text as being fluent.

In an aspect, an entropy model is pre-trained with fluent training samples. When the model is trained on fluent training data, the model will contain more information to generate fluent natural language rather than non-fluent language. The model parameters are adjusted during training to improve the model's ability to make accurate predictions for each token in the output text.

The entropy model is then used to compute an entropy score for each output text that is generated by a particular LLM. In an aspect, the entropy model is a generative model that is used in a non-generative manner to compute an entropy score for the output text. A generative model is a large language model that generates natural language text one token at a time or timestep. The generative model outputs a probability distribution over the model's token vocabulary at each timestep. At each timestep, the top-k tokens are selected from the probability distribution as the most likely tokens to add to a candidate likely to represent the output text. The top-k tokens are the tokens having the highest probability of occurring next in a sequence given the context of the previous tokens in the candidate, where k is a user-defined variable. At the last timestep, one of the candidates is selected as the best output text.

By contrast, the entropy model is used to output a probability distribution at each timestep for each token in the output text which was generated by one of the LLMs. The entropy model is not used to generate an output text rather use the output probability determined by the LLM for each token in the output text to construct an entropy score. In an aspect, the entropy score is a product of the machine-generated token probabilities of each token in an output text generated by a particular large language model. In an aspect, there are three categories: robotic; fluent; and non-fluent. a high entropy score ranges from 0.8 to 1 and is considered non-fluent, medium entropy scores ranging from 0.16 to 0.79 are considered fluent, and a low entropy score ranges from 0 to 0.15 and is considered robotic. The ranges are selected based on the data, architecture or method of training the entropy model.

The output probabilities of the entropy model are used to compute the entropy score rather than using the output probabilities to generate text. The large language model that generated an output text will be biased towards its generation. The entropy model is an independent model that is trained with fluent training samples in a process that is not related to the other large language models.

In an aspect, the entropy-based technique for detecting fluent natural language text is employed in a remote sales web service that manages large volumes of interactions between sales persons and clients across multiple channels. In a remote selling world, sales calls often reach voicemail and are not answered or require a follow-up communication. The remote sales web service may process tens of thousands of sales calls on a weekly basis and due to this volume may not be able respond in a timely manner to a voicemail. Instead, a large language model is used to prepare an email communication that responds to a voicemail in a fluent manner without appearing robotic. The selection of a large language model that generates fluent natural language is difficult when a developer has no knowledge of the training of the LLM or its capabilities. The entropy-based technique disclosed herein overcomes this problem by selecting the best model to generate fluent text by determining the entropy of the model with respect to a given output text.

Attention now turns to a more detailed description of the components, methods, processes, and system for generating fluent natural language text.

### System

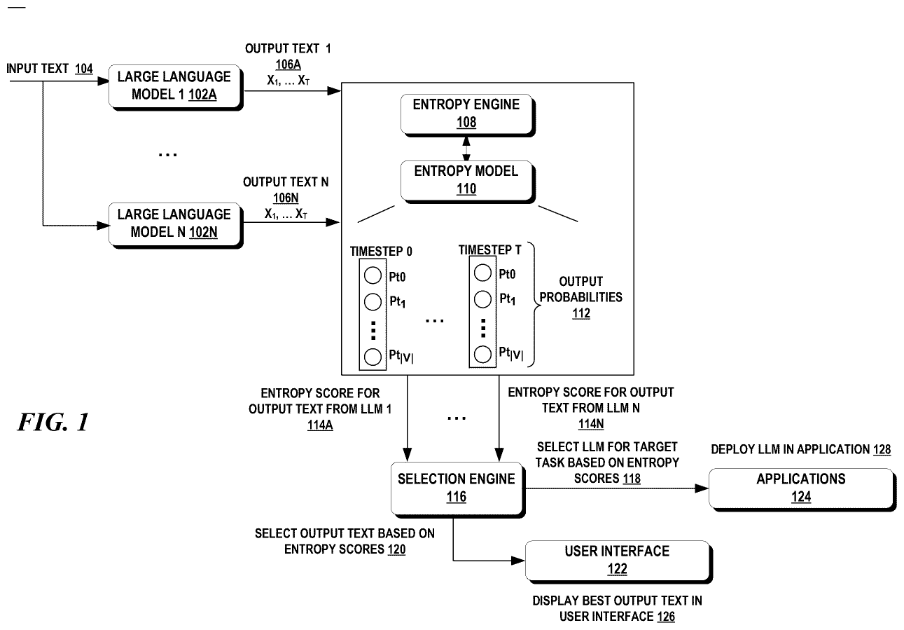

FIG. 1 illustrates a block diagram of an exemplary system for detecting the fluency of machine-generated natural language text 100. The system 100 includes several large language models 102A-102N, an entropy engine 108, an entropy model 110, a selection engine 116, a user interface 122, and one or more applications 124 that utilize a select LLM to produce fluent natural language output for a target task.

In an aspect, the large language models 102A-102N are neural-based deep learning models. A large language model consists of billions of parameters (e.g., weights, biases, embeddings) from being trained on terabytes of data. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

There are various configurations of a neural transformer model with attention. In an aspect, the large language model is configured as a generative model in either an encoder-decoder configuration or a decoder-only configuration. The encoder-decoder neural transformer model with attention has a series of stacked encoder blocks coupled to a series of stacked decoder blocks. The decoder-only neural transformer model with attention consists only of stacked decoder blocks.

In an aspect, the large language model may be a generative neural transformer model with attention previously pre-trained on natural language text and made publicly available. The training of a large language model requires a considerable amount of training data and computing resources which makes it impossible for some developers to create their own models. As such, publicly-available models are often selected and then given additional training for an intended task. Examples of such large language models include the pre-trained generative neural transformer models with attention offered by OpenAI i.e., ChatGPT and Codex models, PaLM and Chinchilla by Google, and LLaMa by Meta. One of these large language models is then be pre-trained on a training dataset of fluent training samples to serve as the entropy model 110.

Each of the LLMs 102A-102N generate a respective output text 106A-106N for an input text 104. Each of the output texts 106A-106N is analyzed by the entropy engine 108. The entropy engine 108 generates an entropy score 114A-114N for each output text 106A-106N using the entropy model 110. In an aspect, the entropy model is a neural transformer model with attention trained on fluent training samples. The entropy model 110 is given the output text generated from each LLM to generate an output probability 112 at each timestep T that indicates the likelihood of each token in the output text following the previously-generated tokens. The probability of each token in the output text is extracted from the model's output probability at a timestep and used to compute the entropy score for the output text.

The selection engine 116 receives the entropy scores for the output texts generated by each LLM. In an aspect, the entropy scores 114A-114N are used to select the best LLM for a target task 118 or to select the most fluent output text 120. The entropy score indicates how well the model is trained on the tokens and context of the input text 104. When a LLM is trained on fluent training data similar to the input text, the LLM is more likely to produce fluent output text. When the LLM has not seen the tokens and context of the input text, the LLM is likely to hallucinate or generate non-fluent output text.

In an aspect, an application 124 that use a fluent LLM includes any text-to-text task where the output text is in natural language and read naturally by a human. Examples of such target tasks include, without limitation, the automatic generation of an email in response to a phone call transcript, the automatic generation of a summarization of a telephone call based on a call transcript, the automatic generation of code documentation for a source code library given the source code of the library, the automatic generation of a document describing a software feature based on the specifications and functionality of the software feature, and the automatic generation of a description of an event given user instructions.

Attention now turns to a more detailed description of the entropy model 110.

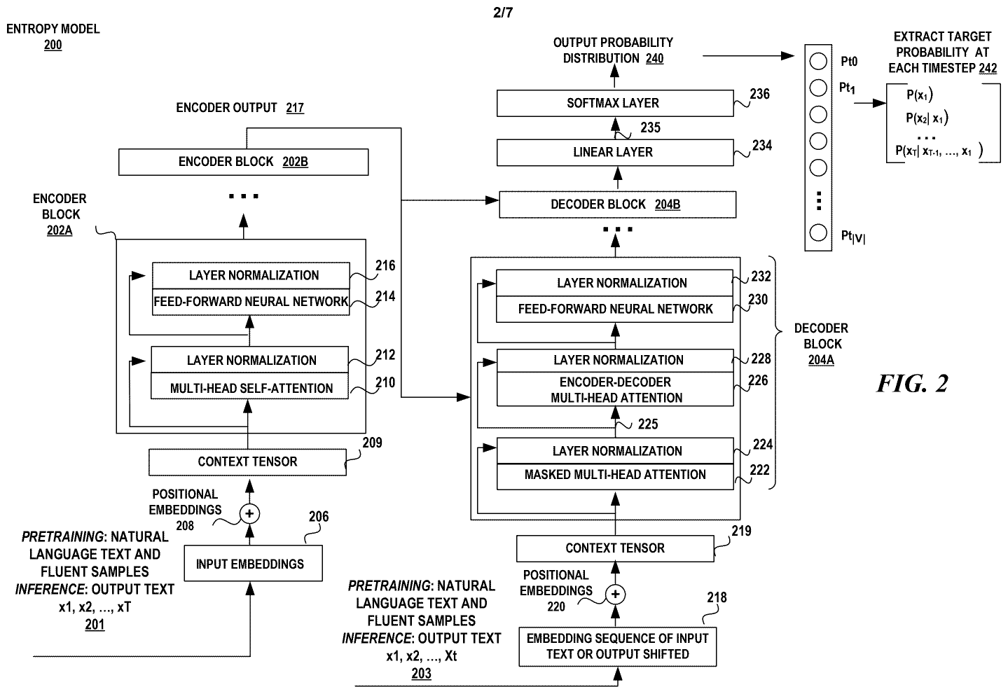

FIG. 2 shows an exemplary structure of the entropy model 200 as a neural transformer model with attention configured in an encoder-decoder configuration. The neural transformer model with attention 200 contains one or more encoder blocks 202A-202B and one or more decoder blocks 204A-204B. The encoder-decoder model 200 is initially pre-trained with natural language text and then pre-trained with fluent training samples.

Training a large language model involves feeding the input data into the LLM and adjusting the model's parameters to minimize the error between the predicted outputs and the actual output. Pre-training refers to using large-scale datasets to train a model on unsupervised data to allow the model to capture essential features and patterns across various domains. The unsupervised data is unlabeled data without specific guidance or labels where the model is trained to reconstruct input data. The unsupervised data may be corrupted with a denoising function for the model to learn to reconstruct the original text. Fine-tuning refers to training the model on supervised data for a specific task. Fine-tuning further adjusts the model's parameters for a target task by utilizing a supervised training dataset specific for a target task. Supervised training data uses labeled data.

During training, the initial inputs to the first encoder block 202A are the input embeddings 206 of a training sample 201. During inference, when the model is trained and used in the generation of the entropy score, the initial input to the first encoder block 202A is input embeddings of the output text generated by an LLM. In order to retain the order of the tokens in the input sequence, positional embeddings 208 are added to the input embedding 206 forming a context tensor 209.

During training, the initial inputs to the first decoder block 204A are the input embeddings 218 of a training sample 203. Thereafter, the inputs are a shifted sequence of the output embeddings from the previous time step to which the positional embeddings 220 are added forming context tensor 219. During inference, when the model is trained and used in the generation of the entropy score, the input to the first decoder block 204A are the input embeddings of the output text generated by an LLM 203. Thereafter, the inputs to the first decoder block 204A are a shifted sequence of the output embeddings 218 from the previous time step to which the positional embeddings 220 are added forming context tensor 219.

An encoder block 202A, 202B consists of two layers. The first layer includes a multi-head attention component 210 followed by layer normalization component 212. The second layer includes a feed-forward neural network 214 followed by a layer normalization component 216. The context tensor 209 is input into the multi-head attention layer 210 of the encoder block 202 with a residual connection to layer normalization 212. The output of the layer normalization 212 is input to the feed forward neural network 214 with another residual connection to layer normalization 216. The output of the encoder block 202 is a set of hidden representations 217. The set of hidden representations 217 is then sent through additional encoder blocks, if multiple encoder blocks exist, or to the decoder blocks 204A, 204B.

Attention is used to decide which parts of the input sequence are important for each token, especially when decoding long sequences since the encoder is limited to encoding a fixed-size vector. Attention mechanisms gather information about the relevant context of a given token and then encode that context into a vector which represents the token. It is used to identity the relationships between tokens in the long sequence while ignoring other tokens that do not have much bearing on a given prediction.

The multi-head self-attention component 210 takes a context tensor 209 and weighs the relevance of each token represented in the context tensor to each other by generating attention weights for each token in the input embedding 206. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries Q and keys K of dimension dₖ, and values V of dimension dᵥ. Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

$$\begin{matrix}MultiHead ( Q , K , V ) = Concat ( {head}_{1} , … , {head}_{h} ) {W}^{o} , \\ where {head}_{i} = Attention ( {QW}_{i}^{Q} , {KW}_{i}^{K} , {VW}_{i}^{V} ) ,\end{matrix}$$

with parameter matrices Wᵢ^{Q}ϵ [symbol] Wᵢ^{K}ϵ [symbol] , Wᵢ^{V}ϵ [symbol] and W^{O}ϵ

[symbol]

In order to reduce the training time of the neural transformer, layer normalization is used between the layers. The layer normalization component normalizes the inputs across the features. The mean and standard deviation is computed across the feature dimensions. There is a first layer normalization 212 that precedes the feed forward neural network 214 and a second layer normalization 216 that follows the feed forward neural network 214.

The feed-forward neural network 214 processes each output encoding separately 213. The output of the top encoder block is a set of attention vectors K and V 217 which is used by the encoder-decoder multi-head attention layer 226 of the decoder block 204.

The decoder block 204 predicts each token x; in the target language one-by-one at each time step conditioned on all previously-generated target tokens x₁, . . . xᵢ₋₁. The decoder block 204 consists of three layers. The first layer includes a masked multi-head attention component 222 followed by a layer normalization component 224. The output of the layer normalization component 224 is input into the encoder-decoder multi-head attention component 226 with a residual connection to layer normalization component 228. The second layer includes an encoder-decoder multi-head attention component 226 followed by a layer normalization component 228. The output of layer normalization component 228 is input into the feed forward neural network 230 with a residual connection to layer normalization component 232. The third layer includes a feed forward neural network 230 followed by a layer normalization component 232.

The masked multi-head attention component 222 receives the output embeddings of the previous timestep. The masked multi-head attention component 222 masks the output embeddings from future time steps. The encoder-decoder multi-head attention layer 226 receives queries from the previous decoder layer 225 and the memory keys and values 217 from the output of the encoder block 202. In this manner, the decoder block 204 can attend to every position of the input sequence. The feed-forward neural network 230 processes each output encoding separately. A layer normalization component 224, 228, 232 is used between the layers in order to normalizes the inputs across the features.

The linear layer 234 projects the vector produced by the stack of decoders into a logits vector 235. The softmax layer 236 then turns the scores of the logits vector into probabilities for each token in the model's vocabulary which are positive and normalized 240.

At each timestep, the conditional probability generated for each token in the output text is extracted from the output probability distribution generated by the entropy model 242. For example, at the first timestep, the token probability P(x₁) for the first token of the output text, x1, is extracted from the output probability distribution generated by the entropy model. At the second timestep, the conditional probability generated for the second token of the output text, x2, is extracted from the output probability distribution, P(x2|x1), generated by the entropy model. Each of these token probabilities is then accumulated and used to compute the entropy score for the output text.

### Methods

Attention now turns to a more detailed description of the methods used in the system for entropy-based fluency detection. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

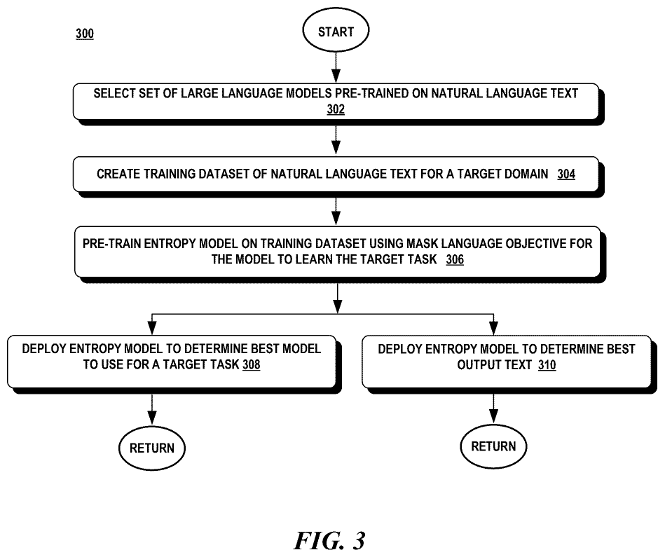

Turning to FIG. 3, there is shown an exemplary method 300 for the entropy-based fluency detection of machine-generated natural language text. One or more large language models are selected for consideration (block 302). The large language models have been pre-trained to generate natural language text. A large language model may be one of the publicly-available pre-trained generative neural transformer models with attention offered by OpenAI i.e., ChatGPT and Codex models, PaLM and Chinchilla by Google, and LLaMa by Meta. The publicly-available models are accessible over a network as a web service. Alternatively, a large language model may be generated locally on a same computing device as a target application. The large language models of the set may be selected based on model size, cost, amount of computing resources needed to operate, etc.

A fluency training dataset is obtained to train the entropy model (step 304). The fluency training dataset consists of fluently-written natural language text. Training samples of fluently-written natural language text may be extracted from known fluent sources such as the Enron Email Dataset (https://www.cs.cmu.edu/˜./enron/), training datasets from HuggingFace, OpenAI, and others. Additionally, the training datasets may be machine-generated from an LLM, such as CoPilot, by asking the LLM to generate robotic, non-fluent and fluent emails.

Each training sample is then transformed into a T-ordered sequence of tokens, where T is the number of tokens in the training sample. A token is a single element in the grammar of a natural language. The T-ordered sequences of tokens are then mapped into numeric vectors and then into an embedding. An embedding is a learned representation for the text-based tokens where tokens that have a common meaning have a common representation. There is an embedding for each token in the training data (i.e., model's vocabulary) and a position embedding. The token embedding represents the learned representation for the token. The entropy model does not read each token sequentially and as such, has no knowledge of the token's position in a sequence without additional position information. The position embedding is used to embed position information about a token's position in a sequence into the transformer model. The token embeddings are input into the model training and inference processing.

The entropy model is pre-trained with the fluency training dataset to create the entropy model (step 306). In an aspect, the entropy model is initially pre-trained on a large corpus of natural language text consisting of trillion of tokens from various domains. From the initial pre-training, the entropy model learns the essential features and patterns of a natural language across various domains. Thereafter, the pre-trained large language model is pre-trained again with the fluency training dataset.

In an aspect, select tokens in a fluency training sample are masked so that the model predicts the masked tokens by using the context provided by the surrounding tokens. A masked language modeling objective is a type of supervised learning in which the model learns to produce text without explicit labels or annotations. Instead, the model draws its supervision from the incoming text. (Collectively, block 306).

The fluency training samples are then applied to the pre-trained large language model thereby adjusting the parameters of the model for the fluency detection task (block 306). Neural transformer models are trained iteratively, making multiple passes over the training dataset before converging to a minimum. An epoch represents the entire training dataset passed forwards and backwards through the neural transformer block once. Since the training dataset is very large, it is partitioned into smaller batches. The training is iterative and the entire dataset is passed through the neural transformer in multiple iterations. Each training iteration includes forward propagation, loss calculation, backpropagation steps followed by updating the weights. The training dataset is partitioned into batches with each batch of sequences running through the training process. (Collectively, block 306).

For each sequence of each batch in each epoch, the T-ordered sequences of tokens are then mapped into numeric vectors and then into respective token embeddings and positional embeddings. An embedding is a learned representation for the text-based tokens where tokens that have a common meaning have a common representation. An embedding is a mapping of discrete categorical variables to a vector of continuous numbers. There is an embedding for each token in the vocabulary of a particular programming language and a corresponding positional embedding. The token embedding represents the learned representation for the token. The neural transformer model does not read each token sequentially and as such, has no knowledge of the token's position in a sequence without additional position information. The positional embedding is used to encode position information about a token's position in a sequence into the neural transformer model. (Collectively, block 306).

Initial values are generated for the token embedding and positional embeddings of each sequence which are then used to form a context tensor. Thereafter, the neural transformer model learns the values for each embedding. Upon the completion of the training phase, the embeddings for each token and the positional embeddings are saved into respective matrices for later use. There is a token embedding matrix, We, that contains an embedding vector for each token tᵢ, i=0 . . . . V of a particular programming language, and a positional embedding matrix, Wp, that contains an embedding vector Pⱼ, j=0 . . . . T, for each position, where V is the size of the vocabulary for a particular programming language and T is the length of the token sequence. (Collectively, block 306).

Referring to FIGS. 2 and 3, the first encoder block 202A of the pre-trained entropy model 200 takes the context tensor 209 as input and passes it through the multiple layers of multi-head attention, layer normalization and feed-forward neural network to finally produce a set of hidden representations If there are additional encoder blocks, the output of each encoder block is passed onto the next encoder block with the output of the last encoder block producing the set of hidden representations 217. The set of hidden representations is passed onto each decoder block 204A, 204B. The linear layer 234 and softmax layer 236 generates output probabilities of each token in the model vocabulary. (Collectively, block 306).

The first decoder block 204A of the entropy model 200 takes a shifted sequence of an output embedding as input. The masking in the masked multi-head attention layer is used to prevent positions from attending to subsequent positions in the future. The masking combined with the output embeddings shifted by one position ensures that the predictions to position T depend only on the known outputs at positions less than T. Starting with the first token of the output sequence, the tokens are passed through the self-attention and normalization layers and into the encoder-decoder attention layer, serving as the query for encoder-decoder attention, where the key and value pairs for the attention are the outputs of encoder. The encoder output was calculated with the entire input embedding sequence. (Collectively, block 306).

The feed forward neural networks in the encoder blocks 202A, 202B and the decoder blocks 204A, 204B are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 306).

Upon completion of the training phases of the entropy model, the entropy model is deployed for a target task. In one aspect, the target task is to determine the best large language model for the generation of fluent natural language text (block 308). In another aspect, the target task is to determine the most fluent natural language text generated by one of the several large language models (block 310).

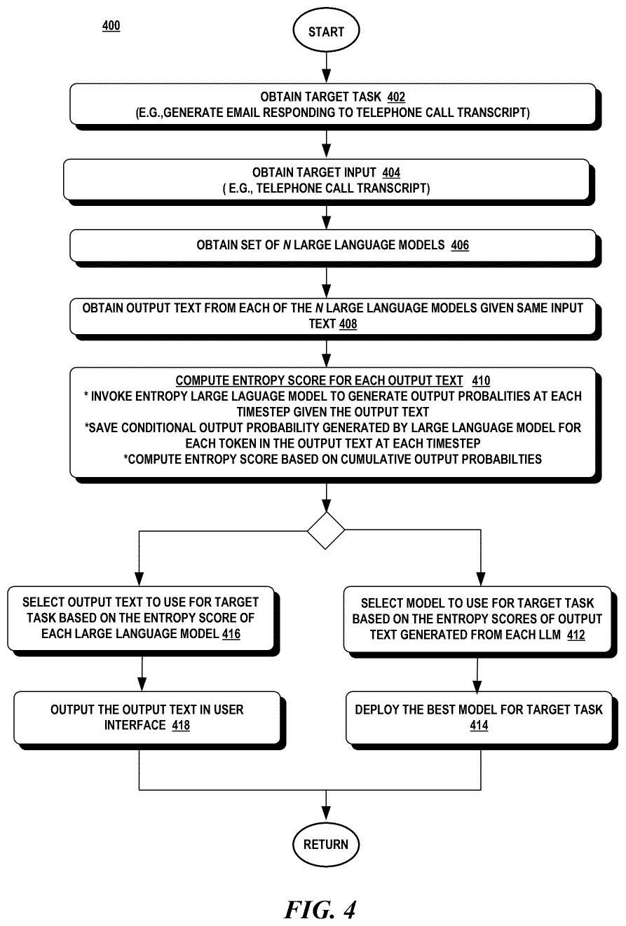

Turning to FIG. 4, there is shown an exemplary method 400 using the entropy-based technique. A target task is selected (block 402) and the target input (block 404). In an aspect, the target task is to generate fluent natural language text for an email responding to a telephone call transcript. The target input is a telephone call transcript written in natural language text. A set of n large language models is selected, where n is a user-defined variable (block 406).

Each large language model is given a prompt that includes an input text consisting of a call transcript and an instruction indicating the target task which is to detect actions needed to respond to the call transcript and to generate an email that responds to the call transcript. Each large language model is given the prompt and generates actions in the email text. (Collectively, block 408).

The prompt to the large language model may be issued using an Application Programming Interface (API). In an aspect, a remote server hosts the large language model and a computing device hosts the entropy engine. The entropy engine and the remote server communicate through HTTP-based Representational State Transfer (REST) APIs. A REST API or web API is an API that conforms to the REST protocol. In the REST protocol, the remote server hosting the large language model contains a publicly-exposed endpoint having a defined request and response structure. The entropy engine issues web APIs containing the prompt to the remote server to instruct the large language model to perform the intended task. The entropy engine receives the response from the large language model as well. (Collectively, block 408).

The entropy engine generates an entropy score for each machine-generated output text. The machine-generated output text consists of an ordered sequence of tokens. Each token of the output text is generated by the large language model, one at a time at each timestep, based on a conditional probability of following the preceding tokens in the output text. The number of timesteps is tied to the number of tokens in the output text. (Collectively, block 410).

The entropy model is given the machine-generated output text and the entropy model computes at each timestep a conditional probability of each token in the model's vocabulary likely to follow the preceding tokens. The entropy engine selects the conditional probability of each token in the output text generated at each timestep. The entropy engine utilizes the entropy model to generate the conditional probabilities for each token in the machine-generated output text. The entropy model is not used to generate natural language text. Instead, the entropy model is used to generate the output probabilities for each token in the machine-generated output text. (Collectively, block 410).

In an aspect, the entropy score quantifies the amount of information the large language model holds for the input text and is represented mathematically as follows:

$$- \frac{1}{T} {\sum }_{t = 1}^{T} {\sum }_{x ∈ V} P ( x ) log P ( x ) ,$$

where T is the number of tokens in the output text, x is a token in the output text input to the entropy model, V is the token vocabulary of the entropy model, and t is the index of a token, x, in the output text that is input to the entropy model.

In an aspect, the entropy score may be computed from a single output text generated by a large language model. In other aspect, the entropy score may be an average of the entropy scores of multiple output texts generated by the same large language model. (Collectively, block 410).

The entropy score is then used to select the most fluent machine-generated output text from the output texts generated by the set of large language models (block 412) which is then output to a user interface (block 414).

The entropy score may also be used to select the large language model of the set that generates the most fluent natural language (block 416). The selected large language model is then deployed in a target application to generate fluent natural language (block 418). Examples of such target applications include without limitation, the automatic generation of an email in response to a phone call transcript, the automatic generation of a summarization of a telephone call based on a call transcript, the automatic generation of code documentation for a source code library given the source code of the library, the automatic generation of a document describing a software feature based on the specifications and functionality of the software feature, and the automatic generation of a description of an event given user instructions.

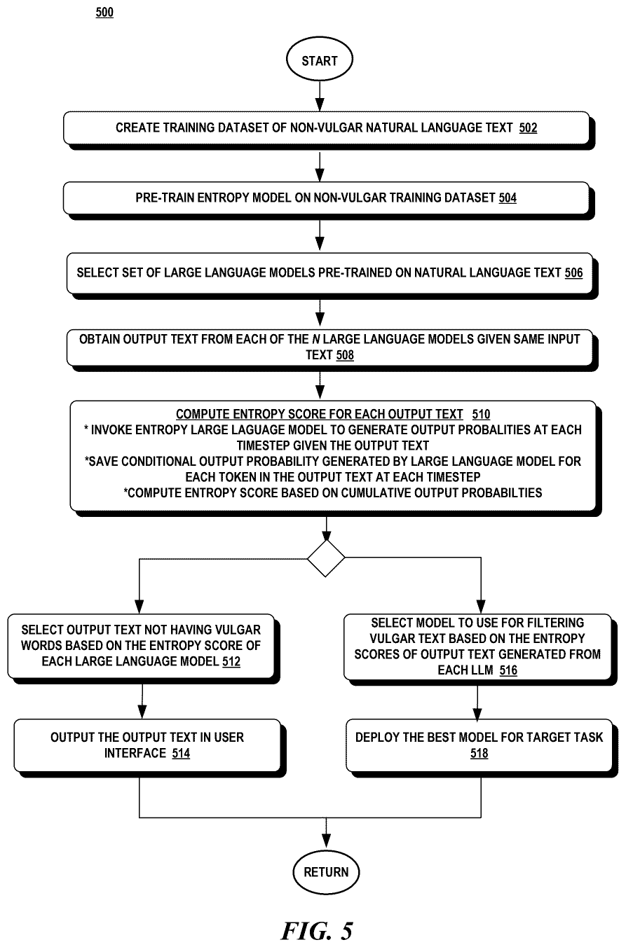

Attention now turns to a discussion of the use of the entropy-based detection technique to filter out emails containing vulgar or swear words or to select a large language model that does not generate natural language text containing vulgar or swear words. Turning to FIG. 5, there is shown an exemplary method 500 using the entropy-based technique to select a large language model that does not generate vulgar words in a natural language text or to filter out a natural language text containing vulgar words.

A training dataset is created containing non-vulgar natural language text samples (block 502). A large language model previously pre-trained on natural language text is obtained and pre-trained on the non-vulgar natural language text samples (block 504). Pre-training the model on the non-vulgar natural language text samples is performed with a masked language objective as discussed above. This training creates an entropy model having a high entropy with regard to vulgar words since it was not trained on the vulgar words (block 504).

A set of n large language models is selected, where n is a user-defined variable (block 506). Each large language model is given a prompt that includes an input text consisting of a call transcript and an instruction indicating the target task which is to detect actions needed to respond to the call transcript and to generate an email that responds to the call transcript. Each large language model is given the prompt and generates an email or output text (block 508).

The entropy engine generates an entropy score for each machine-generated output text as explained above. The entropy engine invokes the entropy model given the output text to generate an output probability at each timestep. The entropy engine saves the conditional output probability for each token in the output text at each timestep. The entropy engine computes the entropy score based on an accumulation of the output probability of each token at each timestep as noted above. (Collectively, block 510).

The entropy score is used to filter out machine-generated output text having vulgar words. A machine-generated output text having a high entropy score is likely to contain vulgar words since the entropy model was not trained on vulgar sentences and as such, has high entropy or surprise when the vulgar words appear in the output text. The entropy engine selects the output text having a low entropy score thereby eliminating the output text having a high entropy score. The selected output text is output to a user interface. (Collectively, blocks 512, 514).

Alternatively, the entropy score is used to select the large language model that does not generate natural language text with vulgar words for a target task. A high entropy score indicates that the output text generated by a large language model is likely to contain vulgar words whereas a low entropy score indicates that the output text is likely to not contain vulgar words. The large language model with the low score is then selected for the target task. (Collectively, blocks 516, 518).

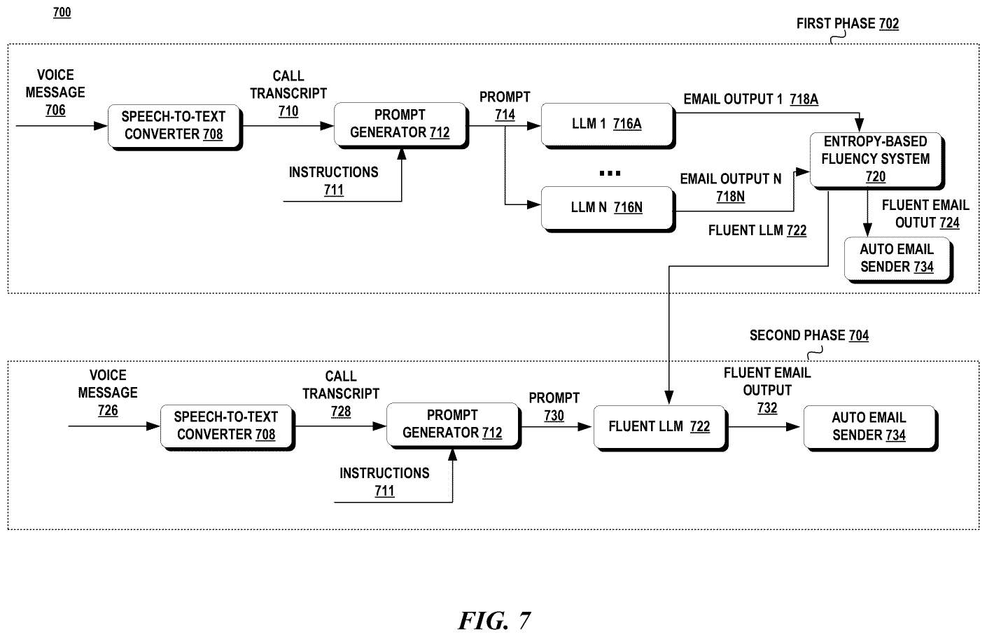

Attention now turns to an exemplary application of the entropy-based detection system. Turning to FIG. 7, there is shown components of an automatic email response system 700 that manages large volumes of interactions between sales persons and clients across multiple channels. In a remote selling world, sales calls often reach voicemail and sometimes are either not answered or require a follow-up communication. The automatic email response system 700 may process tens of thousands of sales calls on a weekly basis in order to timely respond in a voicemail with a fluently-crafted natural language email that does not appear robotic.

In an aspect, the system 700 operates in two phases. In the first phase, the system determines which LLM generates fluent natural language text or which email output from the multiple LLMs contains fluent natural language. In the second phase, the fluent LLM is used to generate fluent emails which are automatically transmitted to the caller.

In an aspect of the first phase 702, a voice message 706 is transformed into a call transcript 710 by a speech-to-text converter 708. A prompt generator 712 receives the call transcript 710 and instructions 711 and generates a prompt 714 to each of the large language models 716A-716N to analyze the call transcript to craft an email 718A-718N responding to the caller's voice message. Each of the large language models generates an email output 718A-718N responding to the prompt which is analyzed by the entropy-based fluency system 720. The entropy-based fluency system 720 selects either the large language model that produces the most fluent email output 722 or selects the email output containing the most fluent natural language 724. In the case of the selecting the most fluent email output, the fluent email is then transmitted to the caller through an auto email sender 734.

In the case of the entropy-based fluency system 720 selecting a fluent large language model, the fluent large language model is deployed in a target application to generate fluent emails that are automatically sent back to the caller. In the target application, a voice message 726 is converted into a call transcript 728 by a speech-to-text converter 708. A prompt generator 712 receives the call transcript 728 and instructions 711 and crafts a prompt the fluent large language model 722. The fluent large language model 722 generates a fluent email output 732 which is then transmitted back to the caller through an auto email sender 734.

In another application, a large language model is trained to generate an email based on user instructions. The entropy model is executed on the output text generated by the large language model and receives a low score indicating that the output text is very robotic. The large language model is run a second time while raising its temperature parameter.

Temperature is a hyperparameter that regulates the randomness in a sampling process. The softmax function of the softmax layer (block 236, FIG. 2) applies a non-linear transformation to the output logits (block 235, FIG. 2) output from the linear layer (block 234, FIG. 2) turning it into a probability distribution (block 240, FIG. 2). The temperature parameter regulates the shape of the probability distribution by redistributing the output probability mass and flattening the distribution proportional to the chosen temperature. This means that for temperature values greater than 1, high probabilities are decreased, while low probabilities are increased. Similarly, temperature values less than 1, high probabilities are increased and low probabilities decreased. Higher temperatures increase entropy and perplexity, leading to more randomness and uncertainty in the generative process. This results in an email that the entropy model considers fluent as it has a medium entropy score.

It should be noted that the entropy-based technique disclosed herein is not limited to generating email responses to a voice message. The disclosed technique can be used for any text-to-text task where the output text is in natural language and read naturally by a human.

### Operating Environment

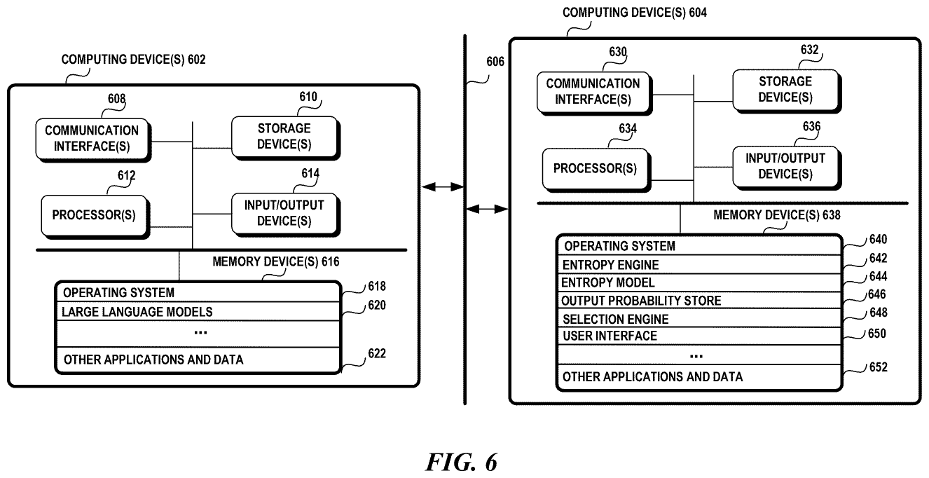

Attention now turns to a discussion of an exemplary operating environment 600. FIG. 6 illustrates an exemplary operating environment 600 having one or more computing devices 602, 604 communicatively coupled to a network 606. In one aspect, large language models may be hosted on a remote web server 602. The language training of the entropy model and the computation of the entropy scores may be processed on a second computing device or web service 604. In another aspect, the large language models may be hosted in the same computing device that produces the entropy score. The aspects of the operating environment are not constrained to a particular configuration.

The computing devices 602, 604 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 500 may be configured in a network environment, a distributed environment, a multi-processor environment, or a stand-alone computing device having access to remote or local storage devices.

A computing device 602, 604 may include one or more processors 612, 634, one or more communication interfaces 608, 630, one or more hardware storage devices 610, 632, one or more input/output devices 614, 636, and one or more memory devices 616, 638. A processor 612, 634 may be any commercially available or customized processor and may include dual microprocessors and multi-processor architectures. A communication interface 608, 630, facilitates wired or wireless communications between the computing device 602, 604 and other devices. A hardware storage device 610, 632 may be computer-readable medium that does not contain propagating signals, such as modulated data signals transmitted through a carrier wave. Examples of a hardware storage device 610, 632 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple hardware storage devices 610, 632, in a computing device 602, 604. The input/output devices 614, 636 may include a keyboard, mouse, pen, voice input device, touch input device, display, speakers, printers, etc., and any combination thereof.

A memory device 616, 638 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 616, 638 may also include one or more external storage devices or remotely located storage devices that do not pertain to propagated signals, such as modulated data signals transmitted through a carrier wave.

A memory device 616, 638 may contain instructions, components, and data. A component is a software program that performs a specific function and is otherwise known as a module, program, component, and/or application. The memory device 616 may include an operating system 618, large language models 620, and other applications and data 622. Memory device 638 may include an operating system 640, an entropy engine 642, an entropy model 644, output probability store 646, selection engine 648, user interface 650, and other applications and data 652.

The computing devices 602, 604 may be communicatively coupled via a network 606. The network 606 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 606 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed pertain to the technical problem of generating fluent machine-generated natural language text. The technical features associated with addressing this problem is the determination of the entropy of a large language model based on its generated output. An entropy model is trained on fluent natural language samples and generate an entropy score indicative of the entropy of a large language model. The entropy score is used to select a large language model that is capable of crafting fluent natural language text or to select the most fluent natural language text generated from a set of large language models. The technical effect achieved is a reduction in the computational resources used by a computing device in producing machine-generated fluent natural language text.

### CONCLUSION

The techniques described herein are an improvement over prior solutions that utilize a single metric to quantify the quality of a LLM for a particular task. For example, the Bilingual Evaluation Understudy (BLEU) metric evaluates the output of a LLM with respect to an expected or ground truth output. The BLEU metric measures precision such as how many n-grams or words in the output appear in the ground truth. Recall-Oriented Understudy for Gisting Evaluation (ROGUE) is a set of metrics used to evaluate summarization and translation tasks by comparing the model-generated natural language output with existing references. A ROGUE metric measures recall which is the completeness or comprehensiveness of the output, such as how many of the n-grams or words in the existing reference appear in the model-generated output.

Those prior solutions are based on the quality of the output text relative to a ground truth output or an existing reference. Instead, the entropy-based technique uses the natural properties of large language model trained on fluent data, which is assigning probabilities to tokens in a natural language text according to likelihood, to quantify the extent to which the machine-generated text is fluent and natural. The entropy model differs by learning the language of natural email without the need to compare it to a correct output. Prior attempts at scoring outputs rely on having a human-being pre-write a natural email for example and then compare the output of the system with it. Hence, these prior solutions cannot work “online”, in a setting where prewritten counterparts are not available for comparison. They are only applicable in an offline setting such as in a lab.

Hence, the entropy-based technique described herein is advantageous over the prior solutions by minimizing the computational overhead incurred by the computing device in generating machine-generated fluent natural language text.

One of ordinary skill in the art understands that the techniques disclosed herein are inherently digital. The operations used to train the entropy model and compute the entropy score based on the output probabilities of each token generated by the entropy model are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments and in testing labs for production environments as opposed to being mere thought experiments. Hence, the human mind cannot perform the operations described herein in a timely manner and with the accuracy required for these intended uses.

A system is disclosed comprising: a processor; and a memory that stores a program that is configured to be executed by the processor. The program comprises instructions to perform actions that: obtain an entropy model trained on fluent natural language text; invoke a plurality of large language models to perform a task that generates an output natural language text given an input natural language text, wherein the output natural language text comprises an ordered sequence of tokens; invoke the entropy model with each of the output natural language text generated by each of the plurality of large language models, wherein the entropy model generates an output probability for each token in a respective output natural language text; compute an entropy score for each of the plurality of large language models, wherein the entropy score for a select large language model is based on output probabilities generated by the entropy model given an output natural language text generated by the select large language model; and upon a select one of the plurality of large language models having a low entropy score, deploy the selected large language model to generate fluent natural language text for a given input text.

In an aspect, the program comprises instructions to perform actions that: upon a select one of the plurality of large language models having a low entropy score, output the output natural language text of the select one of the plurality of large language models as being fluent natural language text.

In an aspect, the program comprises instructions to perform actions that: construct a training dataset of fluent natural language text; and pre-train a large language model with the training dataset using a mask language modeling objective to produce the entropy model.

In an aspect, the program comprises instructions to perform actions that: compute the entropy score as a sum of each probability of each token in the output text. In an aspect, the fluent natural language text comprises non-vulgar language. In an aspect, the input natural language text comprises a call transcript and the output natural language text comprises an email responding to the call transcript.

In an aspect, the plurality of large language models comprises at least one neural transformer model with attention. In an aspect, the entropy model is a neural transformer model with attention.

A computer-implemented method is disclosed, comprising: accessing an entropy model trained on fluent natural language text; invoking at least one large language model to generate an output natural language text for a given an input natural language text, wherein the output natural language text comprises an ordered sequence of tokens; invoking the entropy model with the output natural language text, wherein the entropy model generates a conditional output probability for each token in the output natural language text; determining an entropy score for the at least one large language model by accumulating the conditional output probability generated by the entropy model for each token in the output natural language text; and upon the entropy score indicating low entropy, outputting the output natural language text as fluent natural language.

In an aspect, the computer-implemented method, further comprises: upon the entropy score indicating high entropy, discarding the output natural language text. In an aspect, the entropy score comprises a sum of each probability generated by the entropy model for each token in the output natural language text. In an aspect, the input natural language text is a call transcript, and the output natural language text is an email pertaining to the call transcript.

In an aspect, the computer-implemented method, further comprises: transmitting the email to a caller of the call transcript. In an aspect, the fluent natural language text comprises non-vulgar natural language. In an aspect, the entropy model is a neural transformer model with attention.

A hardware storage device is disclosed having stored thereon computer executable instructions that are structured to be executable by a processor of a computing device to thereby cause the computing device to perform actions that: obtain an entropy model configured to recognize fluent natural language text; invoke a large language model to generate an output natural language text for an input natural language text, wherein the output natural language text comprises an ordered sequence of tokens; generate an output probability for each token in the output natural language text from the entropy model, wherein the entropy model is given the output natural language text, wherein the output probability for each token represents a likelihood of a select token in the output natural language text following previous tokens in the output natural language text; accumulate the output probabilities of each token in the output natural language text generated by the entropy model, wherein the accumulated output probabilities represent an entropy of the large language model; and when the entropy of the large language model meets a threshold, output the output natural language text as fluent and deploy the large language model to generate fluent natural language text for a target application.

In an aspect, the hardware storage device has stored thereon computer executable instructions that are structured to be executable by a processor of a computing device to thereby cause the computing device to perform actions that: when the entropy of the large language model fails to meet a threshold, discard the output natural language text.

In an aspect, the hardware storage device has stored thereon computer executable instructions that are structured to be executable by a processor of a computing device to thereby cause the computing device to perform actions that: pre-train the entropy model with a training dataset comprising fluent natural language samples.

In an aspect, the entropy of the large language model comprises a sum of each probability of each token in the output natural language text generated by the entropy model. In an aspect, the entropy model is a neural transformer model with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A system, comprising:
a processor; and
a memory that stores a program that is configured to be executed by the processor, the program comprises instructions to perform actions that:
obtain an entropy model trained on fluent natural language text;
invoke a plurality of large language models to perform a task that generates an output natural language text given an input natural language text, wherein the output natural language text comprises an ordered sequence of tokens;
invoke the entropy model with each of the output natural language text generated by each of the plurality of large language models, wherein the entropy model generates an output probability for each token in a respective output natural language text;
compute an entropy score for each of the plurality of large language models, wherein the entropy score for a select large language model is based on output probabilities generated by the entropy model given an output natural language text generated by the select large language model; and
upon a select one of the plurality of large language models having a low entropy score, deploy the selected large language model to generate fluent natural language text for a given input text.

2. The system of claim 1, wherein the program comprises instructions to perform actions that:
upon a select one of the plurality of large language models having a low entropy score, output the output natural language text of the select one of the plurality of large language models as being fluent natural language text.

3. The system of claim 1, wherein the program comprises instructions to perform actions that:
construct a training dataset of fluent natural language text; and
pre-train a large language model with the training dataset using a mask language modeling objective to produce the entropy model.

4. The system of claim 1, wherein the program comprises instructions to perform actions that:
compute the entropy score as a sum of each probability of each token in the output text.

5. The system of claim 1, wherein the fluent natural language text comprises non-vulgar language.

6. The system of claim 1, wherein the input natural language text comprises a call transcript, wherein the output natural language text comprises an email responding to the call transcript.

7. The system of claim 1, wherein the plurality of large language models comprises at least one neural transformer model with attention.

8. The system of claim 1, wherein the entropy model is a neural transformer model with attention.

9. A computer-implemented method, comprising:
accessing an entropy model trained on fluent natural language text;
invoking at least one large language model to generate an output natural language text for a given an input natural language text, wherein the output natural language text comprises an ordered sequence of tokens;
invoking the entropy model with the output natural language text, wherein the entropy model generates a conditional output probability for each token in the output natural language text;
determining an entropy score for the at least one large language model by accumulating the conditional output probability generated by the entropy model for each token in the output natural language text; and
upon the entropy score indicating low entropy, outputting the output natural language text as fluent natural language.

10. The computer-implemented method of claim 9, further comprising:
upon the entropy score indicating high entropy, discarding the output natural language text.

11. The computer-implemented method of claim 9, wherein the entropy score comprises a sum of each probability generated by the entropy model for each token in the output natural language text.

12. The computer-implemented method of claim 9,
wherein the input natural language text is a call transcript, and
wherein the output natural language text is an email pertaining to the call transcript.

13. The computer-implemented method of claim 12, further comprising:
transmitting the email to a caller of the call transcript.

14. The computer-implemented method of claim 9, wherein the fluent natural language text comprises non-vulgar natural language.

15. The computer-implemented method of claim 9, wherein the entropy model is a neural transformer model with attention.

16. A hardware storage device having stored thereon computer executable instructions that are structured to be executable by a processor of a computing device to thereby cause the computing device to perform actions that:
obtain an entropy model configured to recognize fluent natural language text;
invoke a large language model to generate an output natural language text for an input natural language text, wherein the output natural language text comprises an ordered sequence of tokens;
generate an output probability for each token in the output natural language text from the entropy model, wherein the entropy model is given the output natural language text, wherein the output probability for each token represents a likelihood of a select token in the output natural language text following previous tokens in the output natural language text;
accumulate the output probabilities of each token in the output natural language text generated by the entropy model, wherein the accumulated output probabilities represent an entropy of the large language model; and
when the entropy of the large language model meets a threshold, output the output natural language text as fluent and deploy the large language model to generate fluent natural language text for a target application.

17. The hardware storage device of claim 16 having stored thereon computer executable instructions that are structured to be executable by a processor of a computing device to thereby cause the computing device to perform actions that:
when the entropy of the large language model fails to meet a threshold, discard the output natural language text.

18. The hardware storage device of claim 16 having stored thereon computer executable instructions that are structured to be executable by a processor of a computing device to thereby cause the computing device to perform actions that:
pre-train the entropy model with a training dataset comprising fluent natural language samples.

19. The hardware storage device of claim 16, wherein the entropy of the large language model comprises a sum of each probability of each token in the output natural language text generated by the entropy model.

20. The hardware storage device of claim 16, wherein the entropy model is a neural transformer model with attention.
